(19) United States
(12) Patent Application Publication
(10) Pub. No.: US 2010/0096764 A1
(43) Pub. Date: Apr. 22, 2010

(54) Gas Environment for Imprint Lithography

(75) Inventor: Xiaoming Lu, Cedar Park, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/576,556

(22) Filed: Oct. 9, 2009

Related U.S. Application Data
(60) Provisional application No. 61/106,676, filed on Oct. 20, 2008.

(51) Int. Cl. B29C 47/76; B28B 21/40

(52) U.S. Cl. 264/39; 425/210

(57) ABSTRACT

Non-uniformity may be minimized by reducing or eliminating non-uniform evaporation of a viscous liquid disposed on the surface of a substrate. At least one gas source component and one vacuum component may provide a mass flow rate of gas across the surface of the substrate to reduce or eliminate non-uniform evaporation.

### CROSS REFERENCE TO RELATED APPLICATIONS

This application claims the priority to, and the benefit of, U.S. Provisional Application No. 61/106,676 filed Oct. 20, 2008, the entire contents of which are incorporated herein by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced-apart from the substrate and a formable liquid applied between the template and the substrate. The region between the template and substrate is subjected to an inert gas flow to remove non-gas flow molecules prior to bringing the template in contact with the formable liquid. The inert gas flow may include carbon dioxide, nitrogen, hydrogen, helium, Freon, neon, or argon gases. A non-symmetrical flow of inert gas or a non-symmetrical pressure gradient across the substrate results in non-uniform evaporation of the formable liquid, which may result in a non-uniform imprint residual thickness layer. Accordingly, additional formable liquid is selectively added to the substrate to account for the non-uniform evaporation of the formable liquid.

The formable liquid is solidified to form a rigid layer that has a pattern conforming to a shape of the surface of the template that contacts the formable liquid. After solidification, the template is separated from the rigid layer such that the template and the substrate are spaced-apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of an embodiment of a lithographic system in accordance with the present invention.

FIG. 2 illustrates a simplified side view of the substrate shown in FIG. 1 having a patterned layer positioned thereon.

FIG. 3 illustrates a template chuck with gas and vacuum nozzles positioned all around.

FIG. 4 illustrates an exemplary template chuck in accordance with an embodiment of the present invention for a smaller sized template.

FIG. 5 illustrates an exemplary template chuck in accordance with an embodiment of the present invention for a larger sized template.

### DETAILED DESCRIPTION

Referring to FIG. 1, illustrated therein is a lithographic system 10 used to form a relief pattern on a substrate 12. Substrate 12 may be coupled to a substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending there from towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit a polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 22 and substrate 12 depending on design considerations. Polymerizable material 34 may comprise a monomer as described in U.S. Pat. No. 7,157,036 and U.S. Patent Publication No. 2005/0187339, all of which are hereby incorporated by reference. An exemplary composition, as incorporated by reference herein from U.S. Pat. Pub. 2005/0187339, has a viscosity associated therewith and further including a surfactant, a polymerizable component, and an initiator responsive to a stimuli to vary said viscosity in response thereto, with said composition, in a liquid state, having said viscosity being lower than 100 centipoises, a vapor pressure of less than 20 Torr, and in a solid cured state, a tensile modulus of greater than 100 MPa, a break stress of greater than 3 MPa, and an elongation at break of greater than 2%.

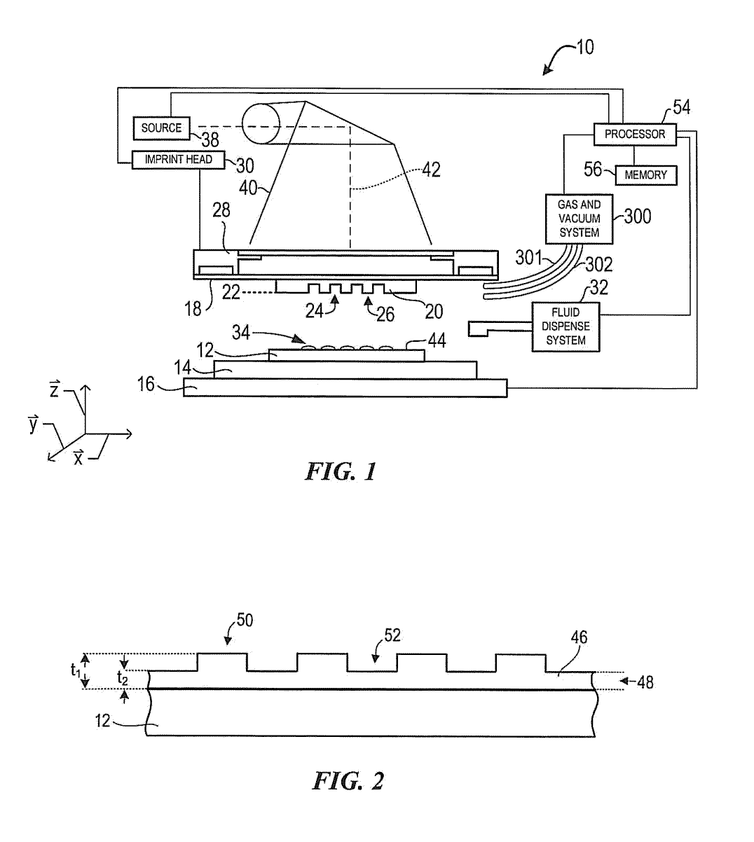

Referring to FIGS. 1 and 2, system 10 may further comprise an energy source 38 coupled to direct an energy 40 along a path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer-readable program stored in a memory 56.

Either imprint head 30, stage 16, or both vary a distance between mold 20 and substrate 12 to define a desired volume there between that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46, as shown in FIG. 2, on substrate 12. Patterned layer 46 may comprise a residual layer 48 and a plurality of features shown as protrusions 50 and recessions 52, with protrusions 50 having thickness t₁ and residual layer 48 having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference herein.

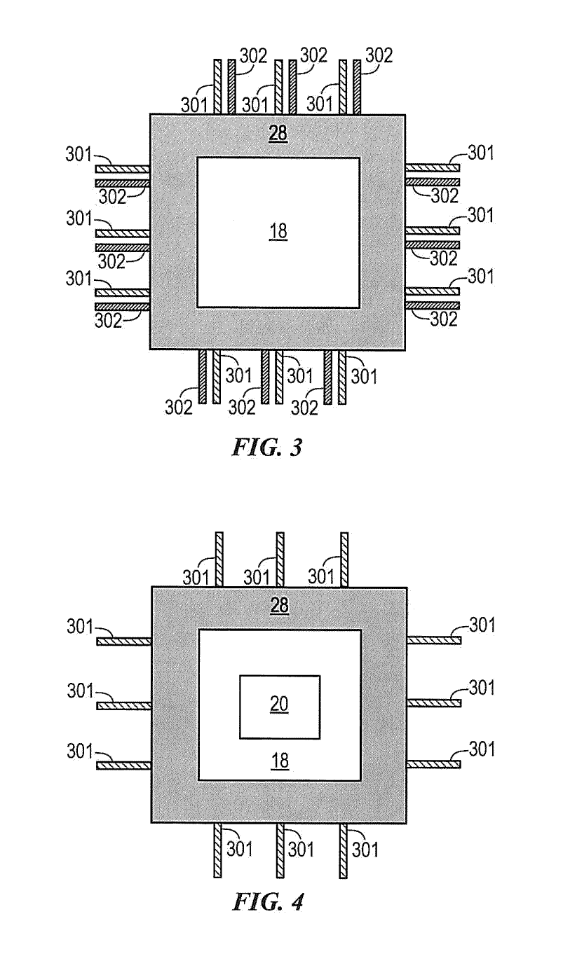

Referring to FIG. 3, a gas and vacuum system 300 may also be implemented to provide one or more sources of inert gases, such as carbon dioxide, nitrogen, hydrogen, helium, Freon, neon, argon, and/or the like, and/or one or more sources of a vacuum, which may be applied during various stages of the aforementioned processes. One example of application of inert gases is further described in U.S. Pat. No. 7,090,716, which is hereby incorporated by reference herein in its entirety.

System 300, or any portion thereof, may be under control of algorithms in programs stored in memory 56 and run in processor 54. FIG. 3 illustrates a plan view of chuck 28 and template 18 showing a positioning of one or more nozzles 301, 302 around a periphery of the chuck 28. For example, gas nozzles 301 and vacuum nozzle 302 may be coupled to system 300 shown in FIG. 1. FIG. 1 only shows a pair of nozzles 301, 302 for the sake of simplicity of illustration and should not be considered limiting as multiple pairs of nozzles 301, 302 and/or singular nozzles 301 or 302 may be used. Further, other means for transporting a gas and/or vacuum to the imprinting area in system 10 may be used to achieve a similar transportation function.

Nozzles 301, 302 may be positioned on one, two, three, or all four sides of the chuck 28 (or any number of sides of chuck 28, should its shape have other than four sides). Although FIG. 3 illustrates nozzles 301, 302 on four sides, nozzles may be limited to less than four sides or greater than four sides. For example, nozzles 301, 302 may be disposed radially around periphery of substrate 12 or template 18 having square, rectangular, triangular or any fanciful shape, and as such, may result in less than or greater than four sides. In one embodiment, nozzles 301 may be positioned as opposing pairs. For example, a first nozzle 301 may be positioned on side 504 with an opposing second nozzle 301 positioned on side 502 directly opposite first nozzle 301. First nozzle 301 and second nozzle 301 may be positioned perpendicular to side 504 and 502 of template 18 respectively. Alternatively, first nozzle 301 and second nozzle 301 may be positioned at an angle to side 504 and 502 of template 18 respectively.

Voids in the patterned layer 46 that are filled with inert gas molecules may disappear with a higher rate due to the higher rate of diffusion and/or dissolution of inert gases into the monomer 34. As such, an inert gas environment may be created between the template 18 and the substrate 12. For example, nozzles 301, 302 located near three sides (e.g., sides 501, 502, and 503) of the template 18 may be adjusted to provide inert gas subsequent to dispensing of monomer 34 on substrate 12 in relation to FIGS. 1 and 2. For example, nozzles 301, 302 located near sides 501, 502, and/or 503 may be adjusted to provide inert gas substantially simultaneously after the monomer 34 is dispensed onto the substrate 12. Alternatively, nozzles 301, 302 located near sides 501, 502, and/or 503 may be adjusted to provide inert gas at consecutive times after the monomer 34 is dispensed onto the substrate 12.

Imprint head 30 may remain at a distance from substrate 12 to provide a dwell time in which inert gas may fill volume between template 18 and substrate 12. Imprint head 30 may then be positioned toward substrate 12 such that distance between template 18 and substrate 12 is reduced. Template 18 may be placed in contact with monomer 34 facilitating spread of monomer between template 18 and substrate 12. Nozzles 301, 302 may be adjusted to discontinue inert gas flow subsequent to spreading of monomer 34 between template 18 and substrate 12.

As can be noted, imprint throughput (how quickly the imprint process can be completed so that a next substrate 12 can be processed) may be affected by, inter alfa, inert gas dwell time. For example, the longer the dwell time the fewer amount of substrates 12 may be processed per unit of time. Additionally, inert gas molecules may escape from side 504 of template 18. During the flow of inert gas, a portion of the monomer 34 dispensed on the substrate 12 in proximity to the fourth side 504 may evaporate, or may evaporate at a higher rate than monomer 34 dispensed in proximity to the first through third sides 501-503. The higher rate of monomer 34 evaporation loss on the fourth side 504 may likely impact the resultant uniformity of the imprint residual layer thickness (RLT).

Referring again to FIGS. 1 and 3, embodiments of the present invention may establish an inert gas environment that eliminates or minimizes dwell time. In one embodiment, system 300 may adjust flow of inert gas from nozzles 301 (e.g., simultaneously) located on the sides (e.g., four sides) of template 18 and template chuck 38 after monomer 34 is dispensed on the substrate 12. For example, flow of inert gas for each nozzle may be between approximately 5 slm and 20 slm. In another example, the inert gas flow may be configured to instantaneously achieve a threshold concentration of inert gas in a region above the substrate 12 (e.g., the threshold concentration in the region above the substrate 12 may be greater than or equal to approximately 90%).

Imprint head 30 may be positioned toward the substrate 12 when a region above substrate 12 exceeds a threshold concentration of the inert gas. Template 18 may be positioned towards substrate 12 at a velocity between 1 mm/sec and 50 mm/sec. Monomer 34 may spread between template 18 and substrate 12. System 300 may then reduce flow of inert gas.

Polymerizable material 34 may evaporate in a substantially uniform fashion, and as such, there may be no need for compensation of thickness t₂ of residual layer 48 resulting from evaporation of monomer 34. For example, pressure gradient of inert gas may be symmetrically distributed such that there is no significant unsymmetrical gas flow from center of template 18 towards edge of mold 20 prior to contact of template 18 to monomer 34 as described in relation to FIGS. 1 and 2. Symmetrical distribution of pressure or gas flow may substantially prevent non-uniform evaporation of monomer 34. Adding monomer 34 to specific portions of substrate 12 to account for non-uniform evaporation may no longer be required. Also, evaporation may be substantially limited once template 18 is in contact with monomer 34 as template 18 and substrate 12 conform to each other in a very short time avoiding further evaporation of monomer 34.

Gas flow may be driven by a pressure gradient. For example, moving velocity of gas flow may be proportional to the pressure increase at gas nozzle 301 and/or gas nozzles 301, 302 distributed around template 18 as illustrated in FIG. 3. Using gas nozzles 301, 302 from sides 501-504 of template 18 may provide a high-pressure region within the center of the region between template 18 and substrate 12. In one example, a pressure gradient may be symmetrically decreasing from a center of the high-pressure region towards the edge of template 18. Reducing the gas flow velocity or minimizing the pressure gradient between template 18 and substrate 12 may reduce the evaporation rate of the liquid monomer 34. As such, a substantially uniform residual layer 48 may be provided.

In the method as described above, an inert gas was purged from three sides (501-503) of the template 18. Since a substantially uniform fluid film is generally desired, the evaporated monomer 34 had to be compensated for by adding more monomer 34 in those areas based on a model of the evaporation. It should be noted that a drop pattern for deposition of monomer 34 may be simplified as compensation for evaporation of monomer 34 may be reduced by providing gas flow as described herein. For example, a substantially uniform evaporation profile may be created by using system 300 and methods to provide symmetrical pressure gradient and/or a known unsymmetrical pressure gradient. As such, additional compensation of monomer 34 due to evaporation may be minimized and/or eliminated.

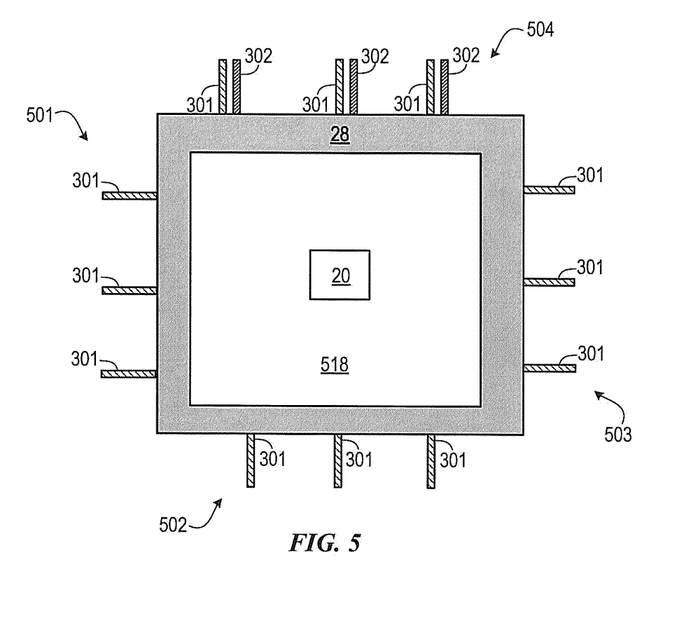

Referring to FIGS. 4 and 5, for a template 518 having an increase in area as compared to template 18 of FIG. 1, inert gas pressure drop (e.g., the fluid flow based on pressure differentials, such as those from areas of high pressure to areas of low pressure; the pressure drop is this pressure differential between the area of high pressure and the area of low pressure) may be increased by adding one or more vacuum nozzles 302 on the one side of template 18 to vacuum gas molecules from the opposite side. For example, nozzles 302 may operate in the range of approximately −10 kPa to −80 kPa.

For example, FIG. 4 shows gas nozzles 301 around the periphery of template chuck 28 for template 18. FIG. 5 shows template 518, wherein vacuum nozzles 302 may be positioned on a single side 504 of chuck 28. An inert gas environment may be established. For example, system 300 may be adjusted to provide a gas flow from nozzles 301 located on side 501, side 503, and/or bottom side 502 of template 18 (e.g., simultaneously, consecutively). System 300 may be adjusted to provide gas flow from nozzles 302 located at side 504 of template 18 and/or chuck 28. Imprint head 30 may be positioned toward substrate 12. For example, template 18 may be positioned toward substrate 12 at a velocity between 1 mm/sec and 50 mm/sec. System 300 may adjust nozzles 302 located at side 504 of template 18 to reduce gas flow. System 300 may adjust nozzles 301 located at side 504 of template 18. Monomer may spread between template 18 and substrate 12. System 300 may adjust nozzles 301 to reduce gas flow once spread of monomer 34 is complete.

Although the device and method has been described in language specific to structural features and/or methodological acts, it is to be understood that the method defined in the appended claims is not necessarily limited to the specific features or acts described. Rather, the specific features and acts are disclosed as exemplary forms of implementing the claimed system and method.

1. A method for reducing non-uniformity of an imprint residual layer thickness on a substrate having polymerizable material deposited thereon, the method comprising:
dispensing a mass flow rate of gas towards the substrate to create a substantially symmetrical pressure gradient from a center of the substrate to an edge of the substrate, the center of the substrate having a higher pressure then the edge of the substrate.

2. The method of claim 1, wherein dispensing the mass flow rate of gas is configured to minimize a dwell time, the dwell time being the amount of time between the start of dispensing the mass flow rate of gas and moving an imprint head towards the substrate.

3. The method of claim 2, wherein moving the imprint head towards the substrate begins when a concentration of the mass flow rate of gas in a region above the substrate is greater than or equal to about 90%.

4. The method of claim 1, wherein the dispensing of the mass flow rate of gas towards the substrate is configured to be substantially uniform along the edge of the substrate.

5. The method of claim 1, wherein the dispensing of the mass flow rate of gas towards the substrate includes disposing a plurality of opposing nozzles on a first side and a second side of the substrate.

6. The method of claim 1, wherein the dispensing of the mass flow rate of gas towards the substrate includes a plurality of gas nozzles radially disposed about a center of the substrate.

7. The method of claim 1, wherein the mass flow rate of gas ranges between about 5 slm and 20 slm.

8. A method for reducing non-uniformity of an imprint residual layer thickness on a substrate having polymerizable material deposited thereon, the method comprising:
balancing a mass flow rate of gas across the substrate to create a substantially uniform pressure across a surface of the substrate.

9. The method of claim 8, wherein balancing the mass flow rate of gas includes a gas source component and a vacuum component, the gas source component and the vacuum component configured to create the substantially uniform pressure across the surface of the substrate.

10. The method of claim 9, wherein the gas source component and the vacuum source component are configured to minimize a dwell time, the dwell time being the amount of time between the start of dispensing the mass flow rate of gas and moving an imprint head towards the substrate.

11. The method of claim 10, wherein moving the imprint head towards the substrate begins when a concentration of the mass flow rate of gas in a region above the substrate is greater than or equal to about 90%.

12. The method of claim 8, wherein the mass flow rate of gas ranges between about 5 slm and 20 slm.

13. The method of claim 9, wherein the vacuum component is configured to operate between about −10 kPa and −80 kPa.

14. A device comprising:
a gas source component configured to provide a mass flow rate of gas and to create a substantially symmetrical pressure gradient from a center of a substrate to an edge of the substrate, the center of the substrate having a higher pressure then the edge of the substrate and having polymerizable material deposited thereon.

15. The device of claim 14, wherein the gas source component is configured to minimize a dwell time, the dwell time being the amount of time between the start of a dispensing the mass flow rate of gas and moving an imprint lithography template towards the substrate.

16. The device of claim 15, wherein moving the imprint lithography template towards the substrate begins when a concentration of the mass flow rate of gas in a region above the substrate is greater than or equal to about 90%.

17. The device of claim 14, wherein the gas source component is configured to dispense the mass flow rate of gas substantially uniform along the edge of the substrate.

18. The device of claim 14, wherein the gas source component is configured to provides a mass flow rate of gas towards the substrate using opposing nozzles positioned on a first side of an imprint lithography template and a second side of an imprint lithography template.

19. The device of claim 14, wherein the gas source component is configured to dispense the mass flow rate of gas using a plurality of gas nozzles radially disposed around the center of the substrate.

20. The device of claim 14, wherein the mass flow rate of gas ranges between about 5 slm and 20 slm.
